(19) United States
(12) Patent Application Publication
(10) Pub. No.: US 2024/0013187 A1
(43) Pub. Date: Jan. 11, 2024

(54) PAYMENT SYSTEM

(71) Applicant: TOSHIBA TEC KABUSHIKI KAISHA, Tokyo (JP)

(72) Inventor: Tsuyoshi Gotanda, Ota Tokyo (JP)

(21) Appl. No.: 18/322,616

(22) Filed: May 24, 2023

(30) Foreign Application Priority Data
Jul. 8, 2022 (JP) 2022-110553

(51) Int. Cl. G06Q 20/20

(52) U.S. Cl. CPC G06Q 20/208

(57) ABSTRACT

An aspect is to provide a payment system that can save space and is easy to handle. A payment system includes: a cart for a customer to carry a merchandise to be purchased; a settlement device configured to make settlement for a purchase price of the merchandise; and a coupling unit configured to couple the cart to the settlement device.

### CROSS-REFERENCE TO RELATED APPLICATION

This application is based upon and claims the benefit of priority from Japanese Patent Application No. 2022-110553, filed on Jul. 8, 2022, the entire contents of which are incorporated herein by reference.

### FIELD

Embodiments described herein relate generally to a payment system that registers merchandise and makes settlement.

### BACKGROUND

Recently, supermarkets and convenience stores have been introducing a self-service checkout machine for a customer to register a merchandise and make settlement. For example, a customer using a self-service checkout machine at a supermarket places a shopping cart (hereinafter simply referred to as a cart) with a merchandise put therein, near the self-service checkout machine, then causes a scanner to read a barcode on the merchandise, and thus carries out registration and settlement processing.

At a supermarket, normally, a self-service checkout area where a plurality of self-service checkout machines are placed is provided in the store and an attendant assists customers in operating the self-service checkout machines.

If customers take carts into the area where a plurality of self-service checkout machines are placed, the carts may strike each other or may obstruct the passage of the customers. Also, if a customer attempts to place a cart as closely as possible to a self-service checkout machine in order not to obstruct the passage of other customers, the cart may strike the self-checkout machine.

Therefore, in the supermarket provided with the self-service checkout area, the self-service checkout area needs to be sufficiently large and this causes a drop in the operational efficiency of the store.

### DESCRIPTION OF THE DRAWINGS

FIG. 1 is a schematic view showing a payment system according to an embodiment.

FIG. 2 is a perspective view showing a self-service POS terminal.

FIG. 3 is a perspective view showing a cart.

FIG. 4 is a perspective view showing a connection device of the self-service POS terminal.

FIG. 5 is a block diagram of a coupling mechanism for coupling the cart to the self-service POS terminal.

FIG. 6 is a block diagram showing a control system.

FIG. 7 is a flowchart showing an example of settlement processing.

FIG. 8 is a flowchart showing an example of left-behind object monitoring processing.

### DETAILED DESCRIPTION

An embodiment described herein is to provide a payment system that can save space and is easy to handle.

In general, according to one embodiment, a payment system includes: a cart for a customer to carry a merchandise to be purchased; a settlement device configured to make settlement for a purchase price of the merchandise; and a coupling unit configured to couple the cart to the settlement device.

An embodiment will now be described with reference to the drawings.

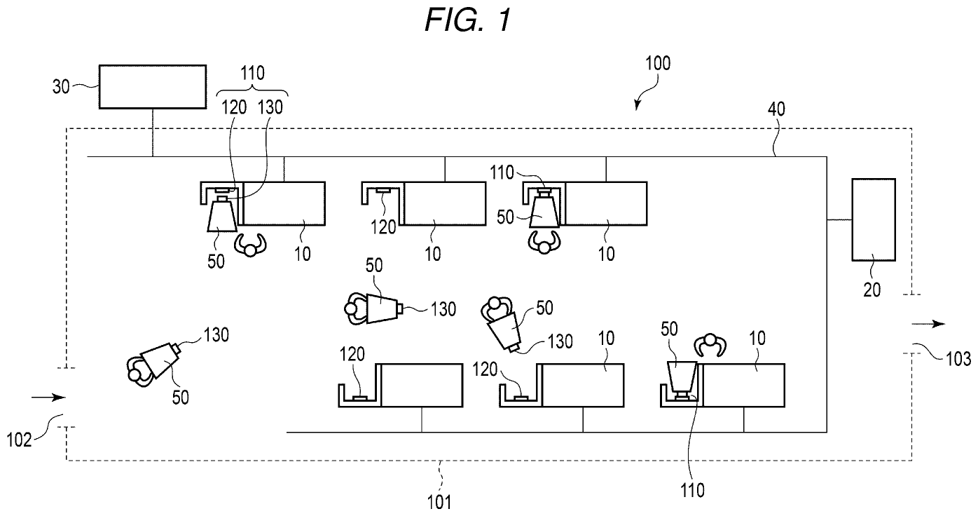

As shown in FIG. 1, a payment system 100 (hereinafter simply referred to as the system 100) includes a plurality of self-service POS (point of sales) terminals 10, an attendant terminal 20, and a store server 30. The plurality of self-service POS terminals 10, the attendant terminal 20, and the store server 30 are connected together via a communication network 40 such as a LAN (local area network). The self-service POS terminal 10 functions as a settlement device. In addition, the system 100 includes a plurality of carts 50 used by customers.

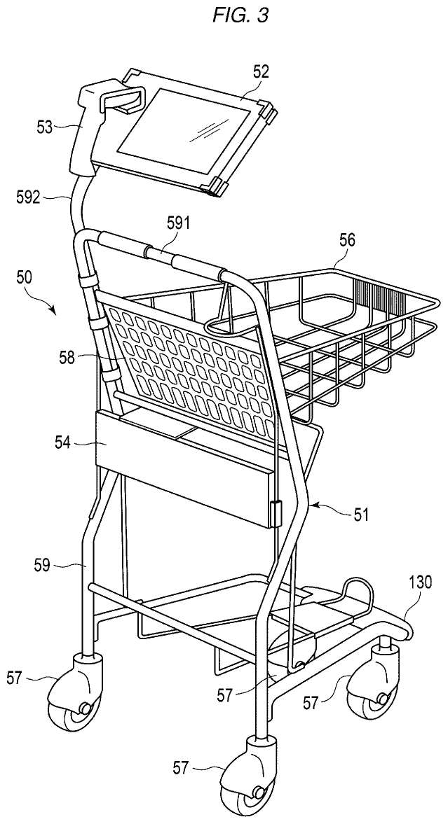

The system 100 has the plurality of self-service POS terminals 10 and the attendant terminal 20 in a self-service area 101 indicated by a dashed line in FIG. 1. The plurality of carts 50 enter the self-service area 101 from an entrance 102 thereof and exits the self-service area 101 from an exit 103. The carts 50 used in the system 100 include both a cart having an electronic device 52 and a handheld scanner 53 (FIG. 3), described later, and a cart without having these components. The store server 30 is located at a different place from the self-service area 101.

A customer puts a merchandise to be purchased into a cart 50, takes the cart 50 into the self-service area 101, and operates the self-service POS terminal 10 to carry out registration and settlement processing of the merchandise. Alternatively, the customer registers a merchandise put in the cart 50 with the electronic device 52 when going around the shopping space, and transmits information about the purchased merchandise (hereinafter referred to as registration data) to the self-service POS terminal 10 at the time of payment and thus carries out only the settlement processing.

The attendant terminal 20 is operated by an attendant at the store. The attendant supports the customer in operating the self-service POS terminal 10. The attendant terminal 20 is located at a position where the exit 103 of the self-service area 101 can be seen. The attendant terminal 20 has a display device, not illustrated, that displays a list or the like of merchandises registered with each self-service POS terminal 10, on a per terminal basis. If an error has occurred at the self-service POS terminal 10, the attendant terminal 20 reports error information about the error.

The store server 30 can provide various services to the plurality of self-service POS terminals 10 and the attendant terminal 20 via the communication network 40. The store server 30 also has a merchandise database that manages data about merchandises sold at the store.

The merchandise database is an aggregate of merchandise records generated on a per merchandise item basis sold at the store. The merchandise record includes, for example, data such as a merchandise code, a merchandise name, and a price. The merchandise code is a univocal code set on a per merchandise item basis in order to identify each individual merchandise. Each merchandise is given a barcode representing the merchandise code of this merchandise. The merchandise name and the price are the unique name and the sales price per item, of the merchandise identified by the merchandise code.

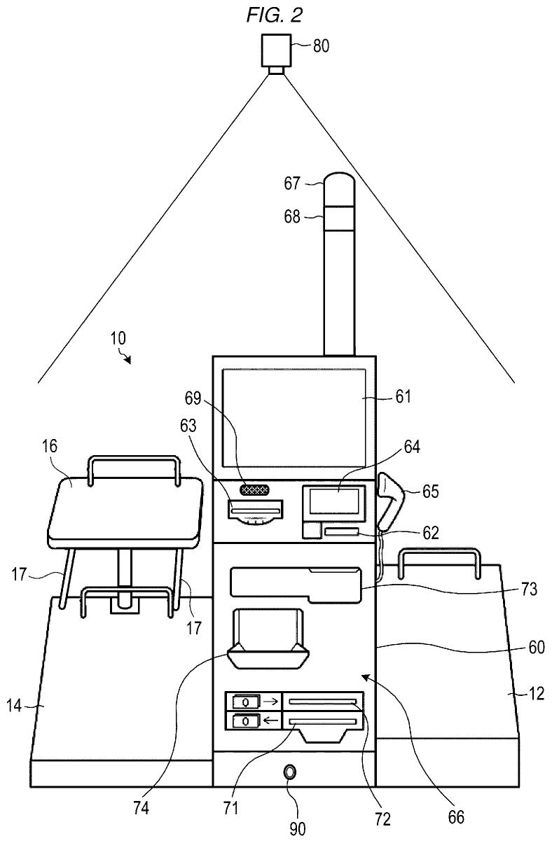

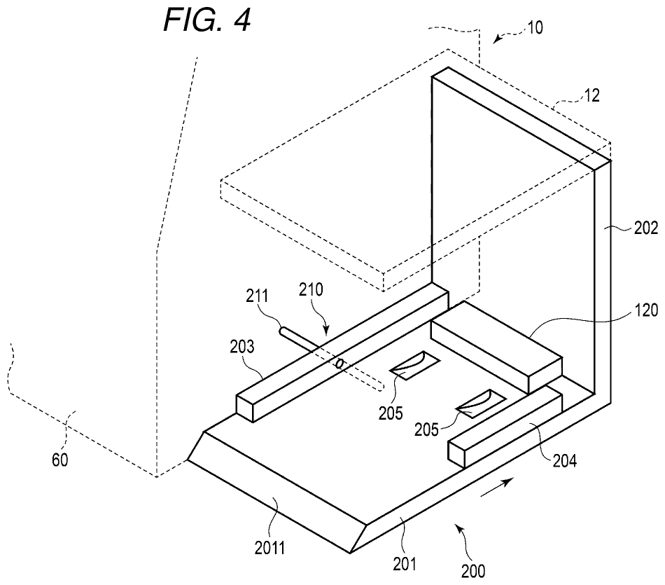

As shown in FIG. 2, the self-service POS terminal 10 includes a main body 60, a basket placing table 12 arranged to the right of the main body 60 in the illustration, a merchandise placing table 14 arranged to the left of the main body 60 in the illustration, and a temporary placing table 16 arranged above the merchandise placing table 14. In addition, the self-service POS terminal 10 includes a terminal-side coupling device 120 (FIG. 4) of a coupling mechanism 110 (FIG. 1), described later, that functions as a coupling unit for coupling the cart 50. The basket placing table 12, the merchandise placing table 14, and the temporary placing table 16 can be reversed in terms of the left and right attachment positions in relation to the main body 60. The attachment positions of these tables can be changed according to the line of movement of the customer.

The basket placing table 12 is a table for a customer to place a shopping basket in which a merchandise to be purchased and yet to be registered is put. A customer who does not use the cart 50 carries a shopping basket by hand, puts a merchandise to be purchased into the shopping basket, and places this shopping basket on the basket placing table 12. The customer then takes out the merchandise from the shopping basket, causes the self-service POS terminal 10 to read the merchandise code, and thus registers this merchandise with the self-service POS terminal 10.

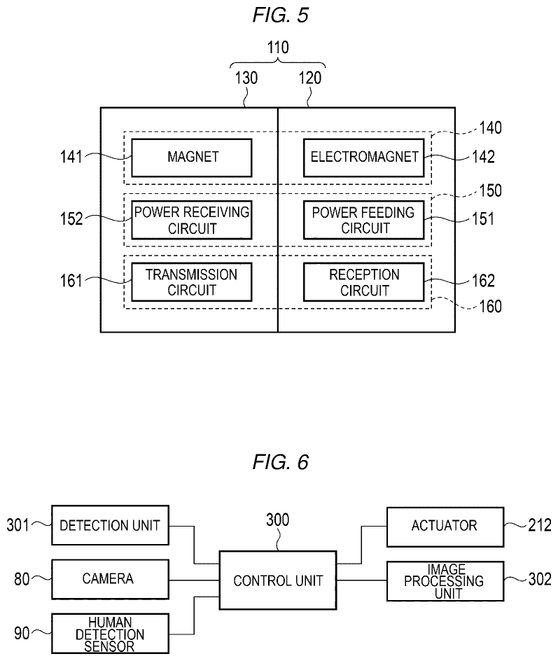

A customer using the cart 50 positions the cart 50 with a merchandise put therein to the self-service POS terminal 10 by a positioning unit 140 (FIG. 5), described later, that is included in the coupling mechanism 110. In the state where the cart 50 is positioned to the self-service POS terminal 10, the merchandise put in a container basket 56 (FIG. 3) of the cart 50 is arranged above the basket placing table 12. In other words, the basket placing table 12 of the self-service POS terminal 10 has a height that does not come into contact with the bottom face of the container basket 56 of the cart 50. If the customer has not registered the merchandise when going around the shopping space, the customer registers the merchandise taken out of the container basket 56 located above the basket placing table 12, with the self-service POS terminal 10.

Below the basket placing table 12, a space for accommodating a caster 57 of the cart 50 is provided. In other words, in the state where the cart 50 is positioned to the self-service POS terminal 10, the basket placing table 12 of the self-service POS terminal 10 enters the space between the container basket 56 and the caster 57 of the cart 50.

In order to notify the customer of the place to put the cart in relation to the self-service POS terminal 10, for example, a guide indication such as “Insert the cart” may be provided at the top face of the basket placing table 12. In this case, a sticker with the guide indication printed thereon may be pasted to the top face of the basket placing table 12. Also, the basket placing table 12 may be formed of a transparent material so that the customer can view the coupling state of the cart 50 to the self-service POS terminal 10 by the coupling mechanism 110.

The merchandise placing table 14 is a table for placing a merchandise already registered with the self-service POS terminal 10. The customer puts the registered merchandise into a shopping basket, a plastic bag, or the customer's own bag or the like placed on the merchandise placing table 14. The customer can also place the registered merchandise directly on the merchandise placing table 14.

The temporary placing table 16 is a table for temporarily placing a merchandise, for example, before putting the merchandise into a plastic bag or the like. The temporary placing table 16 has two protruding holding arms 17 spaced away from each other to the left and right. The customer can attach a plastic bag, the customer's own bag or the like in an open state above the merchandise placing table 14, using these holding arms 17.

The main body 60 of the self-service POS terminal 10 includes a touch panel 61 as an input-output device, a card reader 62, a printer 63, a scanner 64, a handheld scanner a cash processing machine 66, an alarm lamp 67, a light-emitting unit 68, a speaker 69, and the like. The main body performs the registration of the merchandise and the settlement processing of the purchase price.

The touch panel 61 includes a display as a display device, and a touch sensor as an input device. The display displays various screen information such as a payment start screen, a merchandise registration screen, a payment method selection screen, and a payment end screen.

The payment start screen is a screen for accepting the start of settlement. The payment start screen has a “start key” for giving a command to start settlement. If the customer touches the “start key”, the touch sensor detects that the customer has touched the “start key”, and the controller of the self-service POS terminal 10 switches the screen on the display from the payment start screen to the merchandise registration screen.

The merchandise registration screen is a screen showing detail information about a registered merchandise such as the merchandise name, the price, and the total amount. The information about the registered merchandise is added to the screen display each time. The merchandise registration screen has a “payment key” for giving a command to shift to the payment of the price of the merchandise the registration of which is finished. On finishing the registration of all the merchandises, the customer touches the “payment key”. As the touch sensor detects that the “payment key” has been touched, the controller of the self-service POS terminal 10 switches the screen on the display from the merchandise registration screen to the payment method selection screen.

The payment method selection screen is a screen for accepting an input of selection of a payment method such as payment by cash, payment by credit card, payment by electronic money, or payment by code settlement. The payment method selection screen has a “cash key” for giving a command to pay by cash, a “credit key” for giving a command to pay by credit card, an “electronic money key” for giving a command to pay by electronic money, and a “code settlement key” for giving a command to pay by code settlement, or the like. The customer touches a “key” corresponding to a desired payment method.

If, for example, the touch sensor detects that the “cash key” has been touched, the controller of the self-service POS terminal 10 executes settlement processing by cash and switches the screen on the display from the payment method selection screen to the payment end screen by cash.

If the touch sensor detects that the “credit key” has been touched, the controller of the self-service POS terminal 10 executes settlement processing by credit card and switches the screen on the display from the payment method selection screen to the payment end screen by credit card.

If the touch sensor detects that the “electronic money key” has been touched, the controller of the self-service POS terminal 10 executes settlement processing by electronic money card and switches the screen on the display from the payment method selection screen to the payment end screen by electronic money card.

If the touch sensor detects that the “code settlement key” has been touched, the controller of the self-service POS terminal 10 executes settlement processing by a code for code settlement and switches the screen on the display from the payment method selection screen to the payment end screen by code settlement.

For example, the payment end screen by cash is a screen showing the total amount of the transaction, the amount of cash deposit, and the amount of change or the like. For example, the settlement processing by cash is the processing of subtracting the total amount of the transaction from the amount of deposit, thus calculating the amount of change, then dispensing a receipt, and ending the transaction. Such settlement processing by cash is known processing and therefore will not be described further in detail. Similarly, the settlement processing by credit card, electronic money card or code settlement is known processing and therefore will not be described further in detail.

The card reader 62 reads data recorded on a card medium such as a credit card, an electronic money card or a point card. If the card medium is a magnetic card, the card reader 62 is a magnetic card reader. If the card medium is an IC card, the card reader 62 is an IC card reader. The self-service POS terminal 10 may have one or both of a magnetic card reader and an IC card reader, as the card reader 62. The card reader 62 may be a card reader-writer having a function of writing data to a card.

The printer 63 prints data about a purchase receipt, a credit card slip or the like on a receipt paper. The printer 63 prints various data on the receipt paper, cuts the receipt paper by a cutter, and dispenses the receipt from a receipt dispensing port. The printer 63 is, for example, a thermal printer or a dot matrix printer or the like.

The scanner 64 and the handheld scanner 65 are configured to read information identifying a merchandise. In this embodiment, the scanner 64 and the handheld scanner 65 read a barcode attached to a merchandise, as information identifying the merchandise. The scanner 64 optically reads the barcode on the merchandise held over a reading window (glass window) in such a way that the barcode attached to the merchandise faces the reading window. The handheld scanner 65 is configured to be held by hand and operated by the customer. The handheld scanner 65 is moved closely to the barcode attached to the merchandise and thus optically reads the barcode. The scanner 64 and the handheld scanner 65 may be configured to read any information for recognizing a merchandise and may configured to read, for example, information other than a barcode, such as a two-dimensional code.

The cash processing machine 66 processes cash. The cash processing machine 66 includes a banknote insertion port 71, a banknote discharge port 72, a coin insertion port 73, and a coin discharge port 74. The cash processing machine 66 processes a banknote inserted in the banknote insertion port 71. The cash processing machine 66 discharges a banknote as change from the banknote discharge port 72. The cash processing machine 66 accepts and processes a coin inserted in the coin insertion port 73. The cash processing machine 66 discharges a coin as change from the coin discharge port 74.

The alarm lamp 67 is attached to a top end of a pole extending vertically upward in order to be visible from afar. The alarm lamp 67 includes a light-emitting member and a cylindrical member. The light-emitting member is attached inside the cylindrical member. The alarm lamp 67 is configured to give an alert. For example, when an operation has some trouble, the alarm lamp 67 turns on the light-emitting member in a warning color such as red and thus enables the customer or the salesclerk at the attendant terminal 20 to visually confirm that it is an error state. The light-emitting member of the alarm lamp 67 may be attached to be rotatable coaxially with the cylindrical member inside the cylindrical member and may cause the light-emitting member to rotate while emitting light.

The light-emitting unit 68 is arranged below the alarm lamp 67 in the pole. Similarly to the alarm lamp 67, the light-emitting unit 68 includes a light-emitting member and a cylindrical member. The light-emitting member can emit light selectively in a plurality of colors. Alternatively, the light-emitting unit 68 has a plurality of light-emitting members with different light emission colors from each other. Similarly to the alarm lamp 67, the light-emitting unit 68 is configured to give an alert. The light-emitting unit 68 can give an alert indicating that an error has been occurred or that an unauthorized action by the customer has been detected, or the like, based on the light emission color of the light-emitting member, or the light emission color and the flashing state of the light-emitting member.

The speaker 69 outputs a warning sound as an alert or a speech as a message, or the like.

The self-service POS terminal 10 has a camera 80 above the main body 60. The camera 80 picks up an image of the self-service POS terminal 10 and the customer operating the self-service POS terminal 10. The area of the image of the self-service POS terminal 10 picked up by the camera 80 is an area including the basket placing table 12, the merchandise placing table 14, and the temporary placing table 16. The camera 80 picks up an image of substantially the whole body of the customer from above. Therefore, the camera 80 picks up an image of the head, the face, the two shoulders, the chest, the abdomen and the like of the customer.

The main body 60 also has a human detection sensor 90 at the front. The human detection sensor 90 transmits a detection signal indicating that the customer exists, to the controller of the self-service POS terminal 10, while the customer exists within a detection area in front of the self-service POS terminal 10. Based on this detection signal, the controller sets the self-service POS terminal 10 in an idle state while the customer does not exist. The idle state refers to, for example, a standby state where power-saving is achieved by turning off the display of the touch panel 61 or the like. If the self-service POS terminal 10 recognizes the existence of the customer based on the detection signal from the human detection sensor 90, the self-service POS terminal 10 can output a guide sound from the speaker 69 and thus can prompt the customer to perform the first operation.

As shown in FIG. 3, the cart 50 has a cart main body 51, the electronic device 52, the handheld scanner 53, a battery 54, and a cart-side coupling device 130. The electronic device 52 and the handheld scanner 53 are registration devices for registering a merchandise. The cart 50 can move, containing a merchandise therein. In the state where no merchandise is loaded, a plurality of carts 50 can be stacked back and forth. In addition to the handheld scanner 53, a fixed scanner may be fixed and installed in the cart 50.

The cart main body 51 has the container basket 56. In the container basket 56, a merchandise is directly placed or a shopping basket containing a merchandise can be placed. The cart main body 51 has four casters 57 at the bottom end thereof. The cart main body 51 has an opening and closing plate 58 rotationally moving when the cart 50 is stacked. The cart main body 51 has a frame 59 with the container basket 56, the casters 57, and the opening and closing plate 58 attached thereto.

The frame 59 has a handle 591 to be gripped by the customer, at the upper end thereof. The frame 59 has a support rod 592 supporting the electronic device 52 and the handheld scanner 53 arranged above the handle 591. The frame 59 supports the upper end of the opening and closing plate 58 in a rotationally movable manner below the handle 591. The frame 59 supports the container basket 56 in the form of a cantilever protruding forward, facing the front of the opening and closing plate 58.

Therefore, if a front end part of the container basket 56 of another cart 50 is pushed in from the back side of the opening and closing plate 58 of the cart 50 concerned, the opening and closing plate 58 rotationally moves and the container basket 56 of the another cart 50 can be thus stacked on the container basket 56 of the cart 50 concerned and therefore the two carts 50 can be stacked back and forth.

The frame 59 supports the battery 54 below the opening and closing plate 58. The frame 59 holds the cart-side coupling device 130 at a front end of a bottom part. The cart-side coupling device 130, together with the terminal-side coupling device 120 of the self-service POS terminal 10, forms the coupling mechanism 110 coupling the cart 50 to the self-service POS terminal 10.

The coupling mechanism 110 has a function of positioning the cart 50 to the self-service POS terminal 10, a function of supplying electric power from the self-service POS terminal 10 to the cart 50, and a function of transmitting various data from the cart 50 to the self-service POS terminal 10. The coupling mechanism 110 will be described in detail later.

The electronic device 52 provides various information to the customer and also provides various services to the customer. The electronic device 52 is driven by electric power supplied from the battery 54. The electronic device 52 is, for example, an information terminal such as a tablet terminal for providing information to the customer. Alternatively, the electronic device 52 may be a charging device for charging a portable terminal held by the customer with electric power from the battery 54, or the like. For example, the portable terminal held by the customer may be a cellphone, a smartphone, a digital camera, a tablet terminal or the like.

In this embodiment, for example, the electronic device 52 is a tablet terminal. The tablet terminal has, for example, a display unit provided with a touch panel. The support rod 592 supports the tablet terminal at such an angle that the customer standing at a position for gripping the handle 591 can easily view the display unit. For example, the tablet terminal displays information about a merchandise read by the handheld scanner 53. The tablet terminal may also register the information about the merchandise read by the handheld scanner 53 and perform settlement processing based on this registration data.

The handheld scanner 53 is a device reading information about a merchandise. The handheld scanner 53 may have a display unit displaying the information about the merchandise thus read. The handheld scanner 53 reads, for example, merchandise identification information such as a barcode attached to the merchandise put in the container basket 56. The handheld scanner 53 may also be an RFID tag reader reading an RFID tag or the like attached to the merchandise. The handheld scanner 53 may also be, for example, a portable terminal held by the customer or a portable terminal owned by the store. If a portable terminal is used instead of the handheld scanner 53, for example, a camera provided in the portable terminal may read the merchandise identification information such as a barcode.

The customer uses the handheld scanner 53 to read the identification information of the merchandise to be purchased and puts the merchandise into the container basket 56. That is, the customer using the cart 50 having the electronic device 52 and the handheld scanner 53 can register the merchandise at the timing of putting the merchandise to be purchased into the container basket 56 of the cart 50. Therefore, if the customer uses the cart 50 having the electronic device 52 and the handheld scanner 53, the customer only has to transmit an ID code or the like linked to the registration information of the merchandise to be purchased from the cart 50 to the self-service POS terminal 10 at the time of payment at the self-service POS terminal 10. In this case, the customer does not perform registration processing of the merchandise using the scanner 64 or the handheld scanner 65 of the self-service POS terminal 10.

The battery 54 is a power supply device for causing the electronic device 52 to operate. The battery 54 includes a secondary battery storing electric power and a charging circuit charging the secondary battery. The charging circuit stores, in the secondary battery, electric power fed from the self-service POS terminal 10 via a power feeding unit 150 (FIG. 5), described later, of the coupling mechanism 110. The battery 54 supplies the electric power stored in the secondary battery to the electronic device 52. Alternatively, the electric power fed from the self-service POS terminal 10 can be supplied to the electronic device 52 without using the battery 54.

As shown in FIG. 4, the self-service POS terminal 10 has a connection device 200 for docking the cart 50. In FIG. 4, the connection device 200 is shown by a solid line and a part of the self-service POS terminal 10 excluding the connection device 200 is shown by a dashed line. The connection device 200 is installed in a space below the basket placing table 12 located to the right of the main body 60 of the self-service POS terminal 10. If the basket placing table 12 is installed to the left of the main body 60, the connection device 200 is located to the left of the main body 60.

The connection device 200 has a bottom plate part 201 installed on a floor surface, a back plate part 202 standing upward from a back-side end of the bottom plate part 201, two guide members 203, 204 attached to a top face of the bottom plate part 201, and the terminal-side coupling device 120 for coupling the cart-side coupling device 130. The connection device 200 also has a fixing device 210 (fixing unit) fixing the cart 50 in the state of being connected to the self-service POS terminal 10, to the self-service POS terminal 10.

The two guide members 203, 204 are arranged along the direction of movement of the cart 50 indicated by an arrow in FIG. 4 and spaced apart from each other at the left and right ends of the bottom plate part 201. The guide member 203 near the main body 60 of the self-service POS terminal 10 on the left side in the illustration is provided substantially over the full length from the front to the back of the bottom plate part 201. The guide member 204 on the right side in the illustration is shorter than the left-side guide member 203 so as not to interfere with the cart 50 coming from the right side in the illustration.

If the basket placing table 12 is placed to the left of the main body 60 due to the layout of the self-service POS terminal 10, the connection device 200 is arranged to the left of the main body 60. In this case, the two guide members 203, 204 of the connection device 200 are attached in the left-right reversed positions. That is, in this case, the longer guide member is attached on the right side near the main body 60 of the self-service POS terminal 10, and the shorter guide member is attached on the left side.

The two guide members 203, 204 guide the casters 57 at the front end in the direction of movement of the cart 50 so that these casters 57 will not come off outward from the left and right ends of the bottom plate part 201. On the top face of the bottom plate part 201, two recesses 205 are provided at positions for accepting the two casters 57 at the front end of the cart 50. A sloped part sloped downward toward the back plate part 202 may be provided instead of the two recesses 205.

To connect the cart 50 to the connection device 200, the customer puts the two casters 57 at the front end of the cart 50 onto the top face of the bottom plate part 201 via a sloped face 2011 at the front end of the bottom plate part 201 of the connection device 200. As the customer pushes the cart 50, the two casters 57 at the front end fit in the recesses 205 and this restrains the movement of the cart 50. In this state, the cart 50 is positioned to the self-service POS terminal 10, and the cart-side coupling device 130 of the cart 50 is coupled to the terminal-side coupling device 120 of the self-service POS terminal 10.

As described above, the cart 50 can be positioned at a predetermined position in relation to the self-service POS terminal 10 via the two guide members 203, 204 and the two recesses 205 of the connection device 200. Therefore, an inconvenience of the cart 50 forcefully colliding with the self-service POS terminal 10 when being docked with the self-service POS terminal 10 can be prevented.

The fixing device 210 has an actuator 212 (FIG. 6) causing a key rod 211 to move between an operating position indicated by a dashed line in FIG. 4 and a retracted position indicated by a solid line. The actuator 212 is, for example, a ball screw with the key rod 211 serving as a screw shaft, or a rack and pinion having a rack provided on the key rod 211, or the like. If the key rod 211 is moved from the retracted position indicated by the solid line to the operating position indicated by the dashed line in the state where the cart 50 is positioned to the self-service POS terminal 10, the movement of the casters 57 is inhibited and the cart 50 can thus be fixed to the self-service POS terminal 10.

As described above, in this embodiment, the fixing device 210 is provided in the connection device 200 provided in the self-service POS terminal 10. However, the fixing device 210 may be provided in the cart 50. Alternatively, the fixing device 210 may be embedded in the floor of the self-service area 101. In an example where the fixing device 210 is provided in the floor, for example, a device that moves a blade to rise up from the ground may be provided, as in a charged parking space.

FIG. 5 is a block diagram of the coupling mechanism 110 coupling the cart 50 to the self-service POS terminal 10. The coupling mechanism 110 includes the terminal-side coupling device 120 provided in the connection device 200 of the self-service POS terminal 10, and the cart-side coupling device 130 attached to the frame 59 of the cart 50.

The cart-side coupling device 130 has a magnet 141. The terminal-side coupling device 120 has an electromagnet 142 at a position facing the magnet 141. The magnet 141 and the electromagnet 142 are arranged in such a positional relationship as to magnetically attract each other when the cart 50 is docked with the self-service POS terminal 10 by the connection device 200.

The magnetic attraction force of the electromagnet 142 can be changed. The magnetic attraction force of the electromagnet 142 is set to have such a magnitude that the attraction force acts on the magnet 141 of the cart-side coupling device 130 immediately before the two casters 57 provided at the front end of the cart 50 fit in the two recesses 205 in the connection device 200. The magnetic attraction force of the electromagnet 142 can also be set to have such a strength that the cart 50 cannot be easily detached from the self-service POS terminal 10 in the state where the cart 50 is positioned to the self-service POS terminal 10 by the positioning unit 140. That is, the magnet 141 and the electromagnet 142, along with the two guide members 203, 204 and the two recesses 205, function as the positioning unit 140 for positioning the cart 50 to the self-service POS terminal 10.

The coupling mechanism 110 also has the power feeding unit 150 feeding power from the self-service POS terminal to the cart 50 in the state where the cart-side coupling device 130 is coupled to the terminal-side coupling device 120, and a communication unit 160 transmitting various data from the cart 50 to the self-service POS terminal 10. The power feeding unit 150 can perform contactless power feeding. The communication unit 160 can perform wireless communication.

The power feeding unit 150 has a power feeding circuit 151 provided in the terminal-side coupling device 120, and a power receiving circuit 152 provided in the cart-side coupling device 130. The power feeding circuit 151 causes an alternating current to flow through a power feeding coil, not illustrated, and thus generates a change in the magnetic field in the power feeding coil. The power receiving circuit 152 has a power receiving coil, not illustrated, that faces the power feeding coil of the power feeding circuit 151. As the change in the magnetic field is generated in the power feeding coil, an induced voltage is generated in the power receiving coil. This induced voltage can charge, for example, the secondary battery of the battery 54.

The communication unit 160 has a transmission circuit 161 provided in the cart-side coupling device 130, and a reception circuit 162 provided in the terminal-side coupling device 120. The transmission circuit 161 transmits information about a merchandise registered with the electronic device 52 of the cart 50 as registration data via a transmission antenna, not illustrated. The reception circuit 162 receives the registration data transmitted via the transmission antenna.

That is, the coupling mechanism 110 can couple the cart-side coupling device 130 to the terminal-side coupling device 120 in a contactless state. However, in this embodiment, the casing of the cart-side coupling device 130 can be brought into contact with and thus mechanically positioned to the casing of the terminal-side coupling device 120. The coupling of the cart-side coupling device 130 and the terminal-side coupling device 120 of the coupling mechanism 110 enables the positioning of the cart 50 in relation to the self-service POS terminal 10, the power feeding from the self-service POS terminal 10 to the cart 50, and the transmission of various data from the cart 50 to the self-service POS terminal 10. When the cart-side coupling device 130 is coupled to the terminal-side coupling device 120, the charging of the battery 54 may be started without exception.

FIG. 6 is a block diagram of the control system of the foregoing system 100.

The system 100 has a control unit 300. The control unit 300 has a processor and a memory, not illustrated. The processor executes computational processing. The processor performs various processing, for example, based on a program stored in the memory and data used for the program. The memory stores a program and data or the like used for the program. In this embodiment, the control unit 300 is equivalent to the controller provided in each self-service POS terminal 10.

The system 100 has a detection unit 301, the camera 80, the human detection sensor 90, the actuator 212 of the fixing device 210, and an image processing unit 302, which are connected to the control unit 300. The detection unit 301 detects that the cart 50 is docked with the connection device 200 of the self-service POS terminal 10 and positioned to the self-service POS terminal 10 by the positioning unit 140. The detection unit 301 is a mechanical switch, an optical sensor or the like.

The actuator 212 causes the key rod 211 of the fixing device 210 to operate and thus fixes and unfixes the cart 50 in the state of being positioned to the self-service POS terminal 10, to and from the self-service POS terminal 10. The actuator 212 is, for example, a motor driving a ball spring or a rack and pinion.

The image processing unit 302 has an image memory, not illustrated, that stores an image picked up by the camera 80. The image processing unit 302 stores an idle image picked up by the camera 80 when the customer is not operating the self-service POS terminal 10, as a reference image in the image memory in advance. The image processing unit 302 compares the image of the self-service POS terminal 10 picked up by the camera 80 with the reference image read out from the image memory and detects whether or not there is a “left-behind object”, which is an object left behind by the customer at the self-service POS terminal 10.

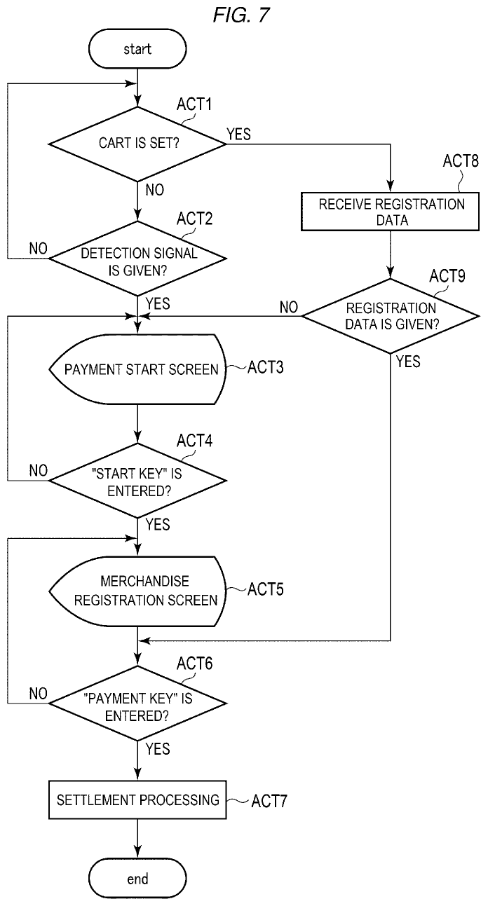

An example of the settlement processing in the system 100 will now be described with reference to a flowchart shown in FIG. 7.

During a standby period before accepting an operation input from a customer, each self-service POS terminal 10 in the system 100 is in the idle state, where the consumption of electric power is restrained. In this idle state, in ACT 1, the control unit 300 of each self-service POS terminal determines whether the cart 50 is positioned to the self-service POS terminal 10 or not, via the detection unit 301. In ACT 2, in parallel with ACT 1, the control unit 300 determines whether a customer has entered the detection area of the human detection sensor 90 or not, via the human detection sensor 90.

If the control unit 300 determines in ACT 2 that a customer has entered the detection area of the human detection sensor 90 before determining in ACT 1 that the cart 50 is positioned to the self-service POS terminal 10 (NO in ACT 1, YES in ACT 2), the control unit 300 determines that it is a transaction by a customer using a shopping basket, and in ACT 3, displays the payment start screen via the display of the touch panel 61.

After displaying the payment start screen, the control unit 300 in ACT 4 waits for the “start key” on the payment start screen to be entered. If the “start key” is entered by the customer (YES in ACT 4) after the payment start screen is displayed, the control unit 300 in ACT 5 switches the screen on the display to the merchandise registration screen. In this state, the customer registers a merchandise to be purchased with the self-service POS terminal 10 while viewing the merchandise registration screen.

After displaying the merchandise registration screen, the control unit 300 in ACT 6 waits for the “payment key” on the merchandise registration screen to be entered. If the “payment key” is entered by the customer having finished the merchandise registration operation (YES in ACT 6), the control unit 300 in ACT 7 shifts to the settlement processing. In the settlement processing of ACT 7, the control unit 300 displays the payment method selection screen and then switches the screen to the payment end screen in response to an operation input from the customer.

Meanwhile, if the control unit 300 detects in ACT 1 that the cart 50 is positioned to the self-service POS terminal 10, via the detection unit 301 (YES in ACT 1), the control unit 300 shifts to ACT 8. In ACT 8, the control unit 300 receives the registration data of the merchandise from the cart 50 via the communication unit 160 of the coupling mechanism 110.

Subsequently, in ACT 9, the control unit 300 determines whether the registration data is successfully received in ACT 8 or not. If the control unit 300 determines in ACT 9 that the registration data is successfully received (YES in ACT 9), the control unit 300 determines that this transaction is a transaction using the cart 50 having the merchandise registration function (having the electronic device 52 and the handheld scanner 53), then shifts to ACT 6, and waits for the “payment key” to be entered. If the “payment key” is not entered (NO in ACT 6), the control unit 300 displays the merchandise registration screen in ACT 5.

If the registration data is not received in ACT 9 (NO in ACT 9), the control unit 300 determines that this transaction is a transaction using the cart 50 without having the merchandise registration function (without having the electronic device 52 and the handheld scanner 53), then shifts to ACT 3, and displays the payment start screen via the display.

After the cart 50 is positioned to the self-service POS terminal 10 in ACT 1 (YES in ACT 1), the control unit 300 may cause the actuator 212 of the fixing device 210 to operate and thus may fix the cart 50 to the self-service POS terminal 10. Alternatively, at this point, the control unit 300 may increase the magnetic attraction force of the electromagnet 142 of the positioning unit 140 of the coupling mechanism 110 and thus may restrain the cart 50 so that the cart 50 cannot easily move, instead of fixing the cart 50 by the fixing device 210. In any case, if the cart 50 is fixed, the control unit 300 unfixes the cart 50 after the settlement processing of ACT 7 is finished.

If the control unit 300 determines in ACT 9 that the registration data is successfully received from the cart 50 (YES in ACT 9), the control unit 300 may cause, for example, the light-emitting member of the light-emitting unit 68 to emit light in a predetermined color (for example, blue) in order to notify the attendant that this transaction has finished the merchandise registration at the cart 50 and only needs the processing for settlement.

According to this embodiment, as in the foregoing example of the settlement processing, the payment for the merchandise at the self-service POS terminal 10 is enabled, based on the detection by the detection unit 301 that the cart 50 is positioned to the self-service POS terminal 10. Therefore, the customer needs to position the cart 50 in relation to the self-service POS terminal 10 in order to execute the payment processing, and an operation by the customer in the state where the cart 50 is placed in an aisle or the like can be prevented. Thus, according to this embodiment, the customer does not operate the self-service POS terminal 10 in the state where the cart 50 is placed in an aisle or the like. Therefore, the inconvenience of obstructing the passage of other carts 50 can be prevented and the collision between the carts 50 can be restrained.

Also, according to this embodiment, the customer taking the cart 50 into the self-service area 101 is to position the cart 50 to the self-service POS terminal 10 without exception in order to perform the settlement processing. Therefore, a plurality of self-service POS terminals 10 can be arranged closely to each other and the device configuration in the entire system 100 can be made compact. Thus, according to this embodiment, the operational efficiency of the store can be improved, compared with the related art.

Also, according to this embodiment, the registration information of the merchandise can be transmitted from the cart 50 to the self-service POS terminal 10 via the communication unit 160 of the coupling mechanism 110 in the state where the cart 50 is positioned to the self-service POS terminal 10. Therefore, if the cart 50 with which the customer has finished the registration of the merchandise when going around the shopping space is positioned to the self-service POS terminal 10, the screen display for the registration of the merchandise at the self-service POS terminal 10 can be omitted. In this case, specifically, the display of the payment start screen can be omitted. Thus, according to this embodiment, the system 100 that is easy to handle can be provided and the convenience for the customer can be improved.

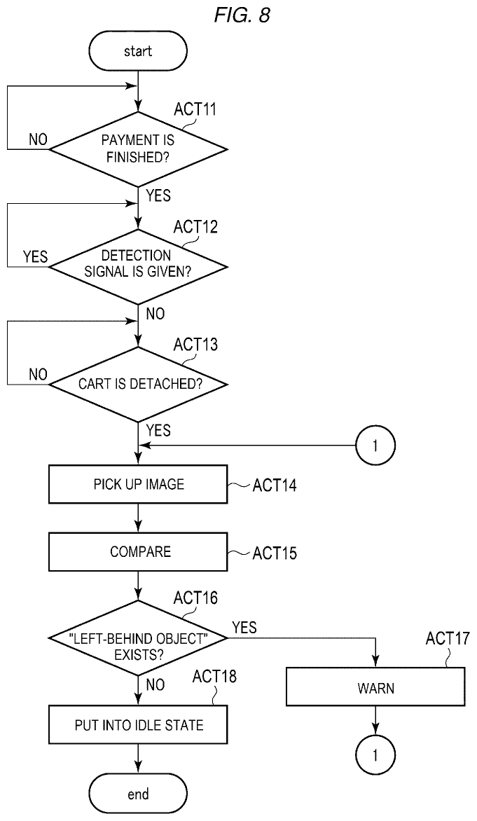

An example of left-behind object monitoring processing in the system 100 according to this embodiment will now be described with reference to a flowchart shown in FIG. 8.

If an “end button” on the payment end screen is entered by the customer after the settlement processing at the self-service POS terminal 10 is finished as described above, the control unit 300 of this self-service POS terminal 10 determines in ACT 11 that the payment processing for this transaction is finished (YES in ACT 11).

Subsequently, in ACT 12, the control unit 300 determines whether the customer is present in front of the self-service POS terminal 10 or not, via the human detection sensor 90. At this point, in ACT 13, the control unit 300 determines whether the cart 50 is detached from the connection device 200 of the self-service POS terminal 10 or not, via the detection unit 301.

If the control unit 300 detects in ACT 12 that the customer has moved away from the front of the self-service POS terminal 10 (NO in ACT 12) and detects in ACT 13 that the cart 50 is detached from the self-service POS terminal 10 (YES in ACT 13), the control unit 300 in ACT 14 picks up an image of this self-service POS terminal 10 with the camera 80.

Subsequently, in ACT 15, the control unit 300 compares the image picked up in ACT 14 with the reference image stored in advance in the image memory. In ACT 16, the control unit 300 determines whether there is any “left-behind object” at this self-service POS terminal 10 or not, based on the result of the comparison in ACT 15.

If the control unit 300 determines in ACT 16 that there is a “left-behind object” (YES in ACT 16), the control unit 300 in ACT 17 gives a warning to the customer and the attendant at the attendant terminal 20. The warning to the customer is, for example, an alert indication by the alarm lamp 67, a warning indication showing a message that there is a “left-behind object” on the display of the touch panel 61 or the display of the attendant terminal 20, a warning via a warning sound or a speech outputted as an alert from the speaker 69, or the like. The warning to the customer may also be a warning indication via the electronic device 52 provided on the cart 50. After giving the warning in ACT 17, the control unit 300 shifts to ACT 14.

Meanwhile, if the control unit 300 determines in ACT 16 that there is no “left-behind object” (NO in ACT 16), the control unit 300 in ACT 18 puts the self-service POS terminal into the idle state and ends the processing.

If the cart 50 is fixed to the self-service POS terminal 10 by the fixing device 210 or the magnetic attraction force of the electromagnet 142 of the positioning unit 140 is increased at the time of starting this transaction, the control unit 300 may cancel the fixed state of the cart 50 after determining in ACT 16 that there is no “left-behind object”.

According to this embodiment, as in the foregoing example of the left-behind object monitoring processing, whether there is any “left-behind object” or not is detected, based on the movement of the customer away from the self-service POS terminal 10 and the detachment of the cart 50 from the self-service POS terminal 10 after the settlement processing is finished. Therefore, the customer and the attendant can be notified whether there is any “left-behind object” or not, at the timing when the customer is about to exit the self-service area 101, and therefore convenience can be improved.

According to this embodiment, if the control unit 300 of the self-service POS terminal 10 determines that there is a “left-behind object”, the detachment of the cart 50 from the self-service POS terminal 10 can be inhibited. Thus, the customer can be more securely prevented from leaving something behind at the self-service POS terminal 10.

In the embodiment, as an example of the settlement device, a self-service POS terminal having a registration processing function of registering a merchandise and a settlement function of performing settlement processing based on information about the registered merchandise is employed. However, the present disclosure is also applicable to a settlement device without having a registration processing function of registering a merchandise but having a settlement function.

While some embodiments have been described, these embodiments are presented simply as examples and are not intended to limit the scope of the present disclosure. These novel embodiments can be carried out in various other forms and can include various omissions, replacements, and modifications without departing from the spirit and scope of the present disclosure. These embodiments and the modifications thereof are included in the spirit and scope of the present disclosure and also included in the scope of the claims and equivalents thereof.

What is claimed is:

1. A payment system, comprising:
a cart for a customer to carry a merchandise to be purchased;
a settlement device configured to make settlement for a purchase price of the merchandise; and
a coupling component configured to couple the cart to the settlement device.

2. The payment system according to claim 1, wherein
the coupling component comprises a positioning component configured to position the cart to the settlement device.

3. The payment system according to claim 1, further comprising:
a fixing component configured to fix the cart to the settlement device.

4. The payment system according to claim 1, wherein
the cart comprises a battery, and
the coupling component comprises a power feeding component configured to feed power from the settlement device to the battery.

5. The payment system according to claim 1, wherein
the cart comprises a registration device configured to register the merchandise.

6. The payment system according to claim 5, wherein
the coupling component comprises a transmission component configured to transmit registration information of the merchandise registered by the registration device to the settlement device.

7. The payment system according to claim 2, further comprising:
a detector configured to detect that the cart is positioned to the settlement device by the positioning component; and
a controller configured to enable execution of settlement processing by the settlement device, based on the detection by the detector that the cart is positioned to the settlement device.

8. The payment system according to claim 1, further comprising:
an electromagnet to facilitate attachment of the cart to the settlement device.

9. A point of sale terminal, comprising:
a cart for a customer to carry a merchandise to be purchased;
a settlement device configured to make settlement for a purchase price of the merchandise;
a camera to capture an image of the settlement; and
a coupling component configured to couple the cart to the settlement device.

10. The point of sale terminal according to claim 9, wherein
the coupling component comprises a positioning component configured to position the cart to the settlement device.

11. The point of sale terminal according to claim 9, further comprising:
a fixing component configured to fix the cart to the settlement device.

12. The point of sale terminal according to claim 9, wherein
the cart comprises a battery, and
the coupling component comprises a power feeding component configured to feed power from the settlement device to the battery.

13. The point of sale terminal according to claim 9, wherein
the cart comprises a registration device configured to register the merchandise.

14. The point of sale terminal according to claim 13, wherein
the coupling component comprises a transmission component configured to transmit registration information of the merchandise registered by the registration device to the settlement device.

15. The point of sale terminal according to claim 10, further comprising:
a detector configured to detect that the cart is positioned to the settlement device by the positioning component; and
a controller configured to enable execution of settlement processing by the settlement device, based on the detection by the detector that the cart is positioned to the settlement device.

16. The point of sale terminal according to claim 9, further comprising:
an electromagnet to facilitate attachment of the cart to the settlement device.

17. A payment system comprising a plurality of point of sale terminals according to claim 9.
